(19) United States
(12) Patent Application Publication
(10) Pub. No.: US 2020/0114203 A1
(43) Pub. Date: Apr. 16, 2020

(54) WEARABLE CHALLENGE CREATION BASED ON NEARBY DEVICES

(71) Applicant: International Business Machines Corporation, Armonk, NY (US)

(72) Inventor: Lisa Seacat DeLuca, Baltimore, MD (US)

(21) Appl. No.: 16/159,212

(22) Filed: Oct. 12, 2018

(51) Int. Cl. A63B 24/00; H04W 4/02; H04W 4/21; G06F 1/16

(52) U.S. Cl. CPC A63B 24/0062; A63B 24/0021; H04W 4/023; A63B 2024/0068; G06F 1/163; A63B 2024/0025; A63B 2024/0065; H04W 4/21

(57) ABSTRACT

A method, system and computer program product for generating a wearable challenge for one or more devices within a specified proximity, by: scanning for the devices within the specified proximity that are available to participate in the wearable challenge; sending an invitation to participate in the wearable challenge to one or more of the devices that are available to participate in the wearable challenge; and initiating the wearable challenge in response to at least one the devices accepting the invitation to participate in the wearable challenge.

### BACKGROUND

The present invention relates generally to a method and system for wearable challenge creation based on nearby devices.

As wearable devices, such as fitness trackers and other devices, become more common, they can benefit from network effects. Specifically, the value of wearable devices increases as the number of users increases.

For example, the manufacturers of wearable devices emphasize the social aspect of their products, allowing people to share their exercises with their friends. It has been found that, on average, users with one or more friends using the same fitness tracker took 700 more steps a day than those without.

Moreover, the manufacturers of wearable devices can benefit from the social engagement aspects for fitness trackers. A large community of users for a specific brand of wearable devices will help the manufacturer differentiate itself from the competition. If your friends are using specific brand of wearable devices, including recording and sharing their data, you will likely want to purchase the same brand of wearable device, and not a device produced by a rival manufacturer.

Nonetheless, laziness is a part of human nature, and people often stop using their fitness trackers. It has been estimated that the abandonment rate of fitness trackers is 30%. However, social engagement involving fitness trackers could mitigate this abandonment rate. If your friends can see whether you exercise, you become less likely to skip workouts.

In addition, competition is a strong motivator for continued use of fitness trackers. Competition is even more fierce when competitors can see each other face to face. However, most competitions involving fitness trackers are done virtually.

What is needed, then, is a system and method for increasing the social engagement aspects for wearable devices, including supporting challenges in the real world. The present invention satisfies this need.

### SUMMARY

The invention provided herein has many embodiments useful, for example, in implementing a method, system and computer program product for generating a wearable challenge for one or more devices within a specified proximity, by: scanning for the devices within the specified proximity that are available to participate in the wearable challenge; sending an invitation to participate in the wearable challenge to one or more of the devices that are available to participate in the wearable challenge; and initiating the wearable challenge in response to at least one the devices accepting the invitation to participate in the wearable challenge.

The scanning for devices may comprise: scanning for devices with similar features; scanning for devices participating in similar activities; and/or scanning for devices of users having similar characteristics, wherein the similar characteristic comprises: a demographic preference, an activity level, a calendar schedule, a social media relationship, a common event participant, or a location.

### BRIEF DESCRIPTION OF THE DRAWINGS

Referring now to the drawings in which like reference numbers represent corresponding parts throughout:

FIG. 1 is a pictorial representation of an illustrative cloud computing environment used for implementing a wearable challenge creation based on nearby devices, according to one embodiment.

FIG. 2 is a block diagram illustrating how the system and method for generating a wearable challenge for one or more devices within a specified proximity is implemented, according to one embodiment.

FIGS. 3A and 3B illustrate a use case for a wearable challenge creation based on nearby devices, according to one embodiment.

FIG. 4 illustrates a set of functional abstraction layers provided by the cloud computing environment.

### DETAILED DESCRIPTION

In the following description, reference is made to the accompanying drawings which form a part hereof, and in which is shown by way of illustration one or more specific embodiments in which the invention may be practiced. It is to be understood that other embodiments may be utilized, and structural and functional changes may be made without departing from the scope of the present invention.

### Cloud Computing Environment

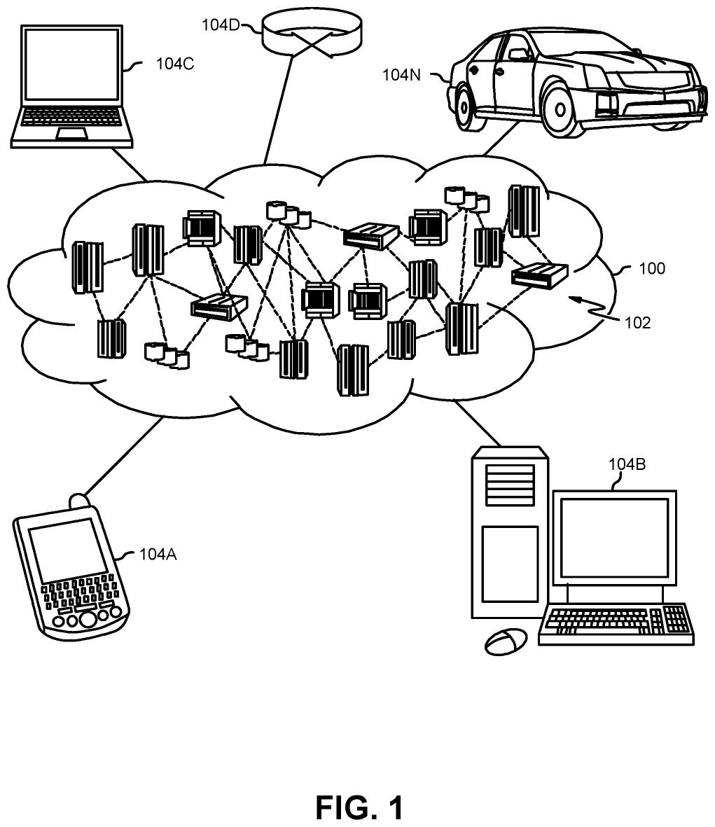

FIG. 1 is a pictorial representation of an illustrative cloud computing environment 100 used for implementing a wearable challenge creation based on nearby devices, according to one embodiment.

As shown, a cloud computing environment 100 includes one or more cloud computing nodes 102 with which local computing devices used by cloud consumers, such as, for example, personal digital assistant (PDA) or cellular telephone 104A, desktop computer 104B, laptop computer 104C, wearable device (e.g., fitness tracker) 104D, and/or automobile computer system 104N may communicate. Nodes 102 may communicate with one another. They may be grouped (not shown) physically or virtually, in one or more networks, such as Private, Community, Public, or Hybrid clouds, or a combination thereof. This allows cloud computing environment 100 to offer infrastructure, platforms and/or software as services for which a cloud consumer does not need to maintain resources on a local computing device. It is understood that the types of computing devices 104A-N shown in FIG. 1 are intended to be illustrative only and that computing nodes 102 and cloud computing environment 100 can communicate with any type of computerized device over any type of network and/or network addressable connection (e.g., using a web browser).

The computing nodes 102 and/or computing devices 104A-N perform various functions and steps as described in more detail below.

### System Description

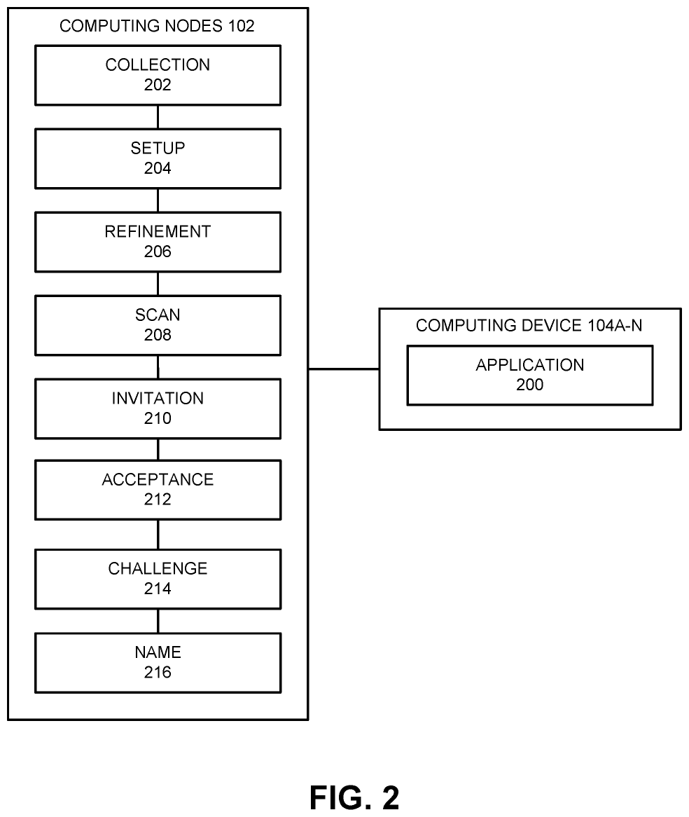

FIG. 2 is a block diagram illustrating how the system and method for generating a wearable challenge for one or more devices within a specified proximity are implemented, according to one embodiment. In this embodiment, the system and method are implemented as follows:
a first person invokes a wearable challenge using an application 200 executed on a first wearable device 104D, wherein other users respond to the wearable challenge using the application 200 executed on other wearable devices 104D; and
the computing nodes 102 perform a plurality of steps or functions 202-216 as set forth below that accept a command from the first wearable device 104D to initiate the wearable challenge and then perform the wearable challenge using the applications 200 executed on the first wearable device 104D and the other wearable devices 104D.

In one embodiment, the wearable devices 104D themselves execute the applications 200. In another embodiment, smartphones 104A, desktop computers 104B, laptop computers 104C, automobile computer systems 104N, and the like, which are paired or otherwise communicatively coupled to the wearable devices 104D, execute the applications 200. In still another embodiment, the smartphones 104A themselves comprise wearable devices 104D and the smartphones 104A execute the applications 200. In this discussion, the references to the wearable devices 104D are intended to encompass all of these embodiments.

In a Collection step or function 202, the computing nodes 102 perform the step or function of collecting the first person's profile data, which may include information on how the first person uses the wearable device 104D, as well as a history of the first person using the wearable device 104D.

In a Setup step or function 204, the computing nodes 102 perform the step or function of setting up the wearable challenge using profile data from the first person, which may include information on whom the first person wishes to challenge. The first person may initiate a wearable challenge for wearable devices 104D with similar features, and/or for wearable devices 104D participating in similar activities. The similar features may comprise applications, capabilities, etc., of the wearable devices 104D; and the similar activities may comprise exercise programs, conferences, etc.

In an optional Refinement step or function 206, the computing nodes 102 perform the step or function of collecting further refinement or preferences for the wearable challenge. The first person may request a wearable challenge with wearable devices 104D nearby whose users have a similar characteristic, wherein the characteristic may comprise a demographic preference, an activity level, a calendar schedule, a social media relationship, a common event participant, or a location The characteristic may comprise, for example, only users of a specified age cohort (e.g., over 55); only users with a certain activity level similar to the user (e.g., invite a user if their daily activity is about 10,000 steps); only users with a similar calendar schedule (e.g., invite a user if they are participating in the conference for the week rather than just being located nearby); social media relationship (e.g., invite a user if they are friends and are located nearby); a specified location (e.g., invite a user if they are presently within a building), etc.

In a Scan step or function 208, the computing nodes 102 perform the step or function of scanning for wearable devices 104D nearby within the specified proximity that are available to participate in the wearable challenge, which may involve the use of proximity technologies, GPS location, Bluetooth sensors, etc. Optionally, the Scan step or function may be scheduled for a specified date and time.

In an Invitation step or function 210, the computing nodes 102 perform the step or function of sending an invitation to participate in the wearable challenge to one or more of the wearable devices 104D that are available to participate in the wearable challenge, wherein the wearable devices 104D were identified in the Scan step or function 208.

In an Acceptance step or function 212, the computing nodes 102 perform the step or function of receiving messages from one or more of the wearable devices 104D accepting or declining the invitation to participate in the wearable challenge.

In a Challenge step or function 214, the computing nodes 102 perform the step or function of initiating the wearable challenge in response to at least one of the wearable devices 104D accepting the invitation to participate in the wearable challenge. Moreover, this step or function may include initiating the wearable challenge in response to a list of participants being finalized. In addition, this step or function may include displaying the results of the challenge on each of the participating wearable devices 104D.

In an optional Name step or function 216, the computing nodes 102 perform the step or function of naming the wearable challenge, and then updating the participating wearable devices 104D with the name. For example, the wearable challenge may be named to match the event or locale where the challenge takes place, or the wearable challenge may be named based on similarities between the participants, or the wearable challenge may be named based on other criteria.

These steps 202-216 may be repeated as necessary, and any one or more of the steps 202-216 may be omitted as required.

### Use Case

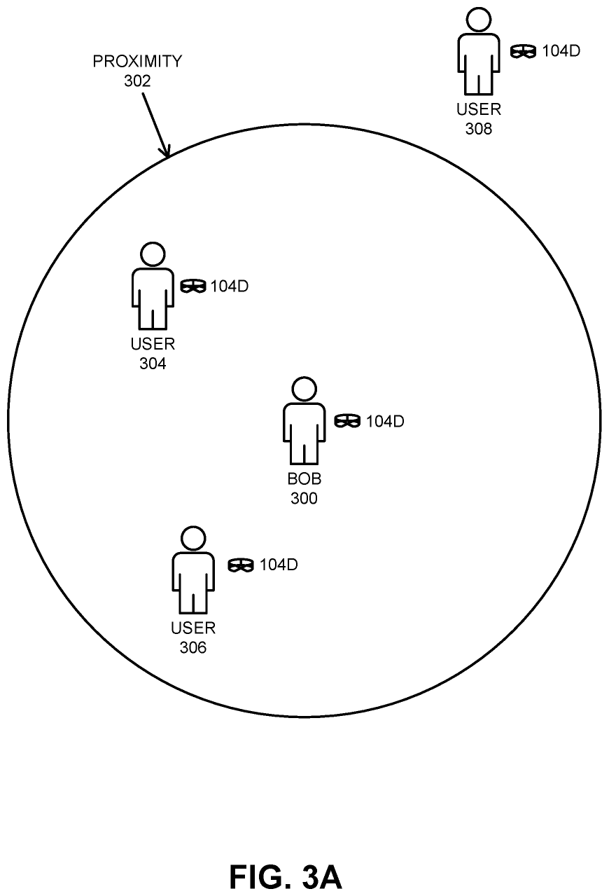

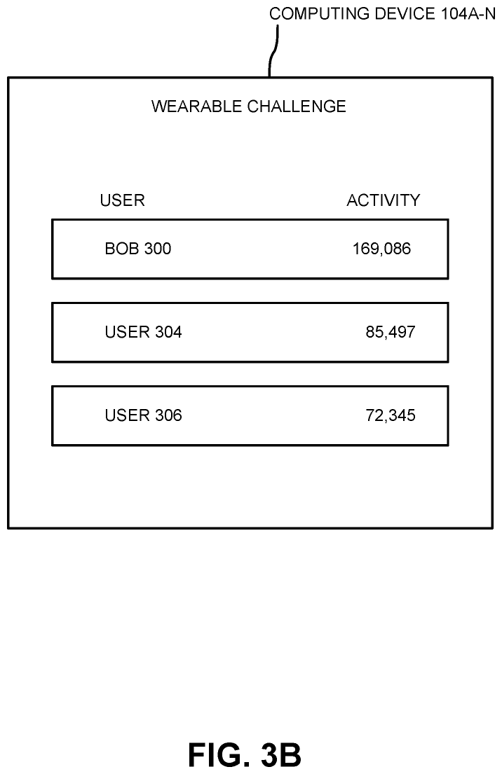

Consider the following use case for generating a wearable challenge with one or more wearable devices 104D within a specified proximity. This use case is illustrated in FIGS. 3A and 3B.

Bob 300 is attending a conference in Las Vegas and is going to be doing a lot of walking throughout the day. He is not friends with other attendees, but wants to challenge himself to get a lot of steps. However, the conference does not start until the next day, so he instructs his wearable device 104D and/or the computing nodes 102 to wait to initiate the challenge until the next morning.

The next morning, Bob's 300 wearable device 104D and/or the computing nodes 102 initiate a scan to look for other wearable devices 104D that can track steps nearby within a specified proximity 302 comprising the conference venue. In this example, other users 304, 306 with such wearable devices 104D are found within the specified proximity 302. Another user 308 with such a wearable device 104D, while sufficiently close to Bob 300 to be scanned, is not within the specified proximity 302, and therefore is not invited to the challenge.

Bob 300 is so motivated by the other users 304, 306 in the wearable challenge that he exceeds his typical weekly fitness goals. In this example, the results of the wearable challenge are displayed on the participating wearable devices 104D, as shown in FIG. 3B. Moreover, the results may be displayed on public monitors (not shown) throughout the conference to further promote the competition.

### Statutory Subject Matter

It can be seen that the present invention provides a number of benefits and advantages. These benefits and advantages include improvements to the technology or technical field of wearable devices, fitness trackers, and exercise aids, and more specifically, for wearable challenge creation based on nearby devices. For example, the present invention enhances the social aspects of wearable devices, allowing people to share their exercises with more than just their friends, which results in increased activity. Increased social engagement also mitigates the high abandonment rate for wearable devices.

These benefits and advantages also include improvements to the functioning of the devices themselves, including the cloud computing environment 100 generally and the computing nodes 102 specifically, as well as the computing devices 104A-N, as compared to prior computer-implemented methods and systems for wearable devices. For example, the present invention improves the functioning of the wearable devices themselves, such as when the wearable devices themselves perform the associated functionality, or when the wearable devices are paired or otherwise coupled to other computing devices, such as smartphones, laptops, desktops, or automobile computers that perform the associated functionality. Moreover, the invention is applied to a particular machine, such as wearable devices or smartphones acting as wearable devices. Using the present invention, the wearable devices can benefit from network effects, as the number of users increases the value of the wearable devices increases. In addition, wearable devices capable of implementing the present invention will also help the manufacturer differentiate itself from their competition, because users are more likely to purchase these wearable devices.

Both generally and specifically, these steps and functions of the computer-implemented method and system comprise specific improvements other than what is well-understood, routine and conventional in the field. Moreover, these steps and functions of the computer-implemented method and system add unconventional steps to a particular useful application.

### Cloud Computing

It is to be understood that this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring again to FIG. 1, illustrative cloud computing environment 100 is depicted. As shown, cloud computing environment 100 includes one or more cloud computing nodes 102 with which local computing devices used by cloud consumers, such as, for example, personal digital assistant (PDA) or cellular telephone 104A, desktop computer 104B, laptop computer 104C, wearable devices 104D, and/or automobile computer system 104N may communicate. Nodes 102 may communicate with one another. They may be grouped (not shown) physically or virtually, in one or more networks, such as Private, Community, Public, or Hybrid clouds as described hereinabove, or a combination thereof. This allows cloud computing environment 100 to offer infrastructure, platforms and/or software as services for which a cloud consumer does not need to maintain resources on a local computing device. It is understood that the types of computing devices 104A-N shown in FIG. 1 are intended to be illustrative only and that computing nodes 102 and cloud computing environment 100 can communicate with any type of computerized device over any type of network and/or network addressable connection (e.g., using a web browser).

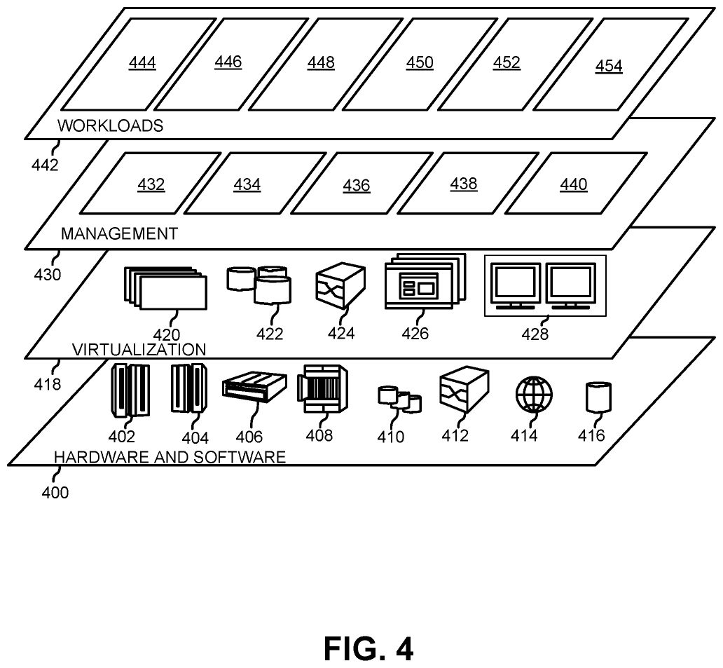

Referring now to FIG. 4, a set of functional abstraction layers provided by cloud computing environment 100 (FIG. 1) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 400 includes hardware and software components. Examples of hardware components include: one or more computers such as mainframes 402, RISC (Reduced Instruction Set Computer) architecture based servers 404, servers 406, and blade servers 408; storage devices 410; and networks and networking components 412. In some embodiments, software components include network application server software 414 and database software 416.

Virtualization layer 418 provides an abstraction layer from which the following examples of virtual entities may be provided: virtual servers 420; virtual storage 422; virtual networks 424, including virtual private networks; virtual applications and operating systems 426; and virtual clients 428.

In one example, management layer 430 may provide the functions described above. Resource provisioning 432 provides dynamic procurement of computing resources and other resources that are utilized to perform tasks within the cloud computing environment 100. Metering and pricing 434 provide cost tracking as resources are utilized within the cloud computing environment 100, and billing or invoicing for consumption of these resources. In one example, these resources may include application software licenses. Security provides identity verification for cloud consumers and tasks, as well as protection for data and other resources. User portal 436 provides access to the cloud computing environment 100 for consumers and system administrators. Service level management 438, which includes containers, provides cloud computing resource allocation and management such that required service levels are met. Service Level Agreement (SLA) planning and fulfillment 440 provide pre-arrangement for, and procurement of, cloud computing resources for which a future requirement is anticipated in accordance with an SLA.

Workloads layer 442 provides examples of functionality for which the cloud computing environment 100 may be utilized. Examples of workloads, tasks and functions which may be provided from this layer include: mapping and navigation 444; software development and lifecycle management 446; virtual classroom education delivery 448; data analytics processing 450; transaction processing 452; etc. More specifically, this layer includes the workloads, tasks and functions for wearable challenge creation 454 based on nearby computing devices 104A-N as described above.

### Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

### Conclusion

This concludes the description of the various embodiments of the present invention. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Since many embodiments of the invention can be made without departing from the spirit and scope of the invention, the invention resides in the claims hereinafter appended.

What is claimed is:

1. A computer-implemented method, comprising:
generating a wearable challenge for one or more devices within a specified proximity, by:
scanning for the devices within the specified proximity that are available to participate in the wearable challenge;
sending an invitation to participate in the wearable challenge to one or more of the devices that are available to participate in the wearable challenge; and
initiating the wearable challenge in response to at least one of the devices accepting the invitation to participate in the wearable challenge.

2. The method of claim 1, wherein the scanning for the devices comprises scanning for the devices with similar features.

3. The method of claim 1, wherein the scanning for the devices comprises scanning for the devices participating in similar activities.

4. The method of claim 1, wherein the scanning for the devices comprises scanning for the devices of users having similar characteristics, wherein the similar characteristic comprises: a demographic preference, an activity level, a calendar schedule, a social media relationship, a common event participant, or a location.

5. The method of claim 1, wherein the scanning for the devices is scheduled for a specified date and time.

6. The method of claim 1, wherein the initiating the wearable challenge comprises initiating the wearable challenge in response to a list of participants being finalized.

7. The method of claim 1, further comprising naming the wearable challenge.

8. A computer-implemented system, comprising:
one or more computers programmed for generating a wearable challenge for one or more devices within a specified proximity, by:
scanning for the devices within the specified proximity that are available to participate in the wearable challenge;
sending an invitation to participate in the wearable challenge to one or more of the devices that are available to participate in the wearable challenge; and
initiating the wearable challenge in response to at least one the devices accepting the invitation to participate in the wearable challenge.

9. The system of claim 8, wherein the scanning for the devices comprises scanning for the devices with similar features.

10. The system of claim 8, wherein the scanning for the devices comprises scanning for the devices participating in similar activities.

11. The system of claim 8, wherein the scanning for the devices comprises scanning for the devices of users having similar characteristics, wherein the similar characteristic comprises: a demographic preference, an activity level, a calendar schedule, a social media relationship, a common event participant, or a location.

12. The system of claim 8, wherein the scanning for the devices is scheduled for a specified date and time.

13. The system of claim 8, wherein the initiating the wearable challenge comprises initiating the wearable challenge in response to a list of participants being finalized.

14. The system of claim 8, further comprising naming the wearable challenge.

15. A computer program product, the computer program product comprising a computer readable storage medium having program instructions embodied therewith, the program instructions executable by one or more computers to cause the computers to perform a method, comprising:
generating a wearable challenge for one or more devices within a specified proximity, by:
scanning for the devices within the specified proximity that are available to participate in the wearable challenge;
sending an invitation to participate in the wearable challenge to one or more of the devices that are available to participate in the wearable challenge; and
initiating the wearable challenge in response to at least one the devices accepting the invitation to participate in the wearable challenge.

16. The computer program product of claim 15, wherein the scanning for the devices comprises scanning for the devices with similar features.

17. The computer program product of claim 15, wherein the scanning for the devices comprises scanning for the devices participating in similar activities.

18. The computer program product of claim 15, wherein the scanning for the devices comprises scanning for the devices of users having similar characteristics, wherein the similar characteristic comprises: a demographic preference, an activity level, a calendar schedule, a social media relationship, a common event participant, or a location.

19. The computer program product of claim 15, wherein the scanning for the devices is scheduled for a specified date and time.

20. The computer program product of claim 15, further comprising naming the wearable challenge.
